(19) United States
(12) Patent Application Publication
(10) Pub. No.: US 2012/0300600 A1
(43) Pub. Date: Nov. 29, 2012

(54) THERMALLY ASSISTED MAGNETIC RECORDING MEDIUM AND MAGNETIC RECORDING AND REPRODUCING DEVICE

(75) Inventors: Tetsuya Kanbe, Chiba-shi (JP); Atsushi Hashimoto, Chiba-shi (JP); Takayuki Fukushima, Ichihara-shi (JP)

(73) Assignee: SHOWA DENKO K.K., Minato-ku, Tokyo (JP)

(21) Appl. No.: 13/574,932

(22) PCT Filed: Jan. 24, 2011
(86) PCT No.: PCT/JP2011/051183

§ 371 Date: Jul. 24, 2012

(30) Foreign Application Priority Data
Jan. 26, 2010 (JP) 2010-014271

(51) Int. Cl. G11B 13/04; G11B 5/66

(52) U.S. Cl. 369/13.32; 428/827; 428/829; G9B/13.002

(57) ABSTRACT

A thermally assisted magnetic recording medium having a structure in which a first magnetic layer 106 and a second magnetic layer 107 are formed on a substrate 101 in this order, wherein the first magnetic layer 106 has a granular structure containing a FePt alloy having a L1₀ structure, a CoPt alloy having a L1₀ crystal lattice structure or a CoPt alloy having a L1₁ crystal lattice structure, and at least one material for causing grain boundary segregation selected from the group consisting of SiO₂, TiO₂, Cr₂O₃, Al₂O₃, Ta₂O₅, ZrO₂, Y₂O₃, CeO₂, MnO, TiO, ZnO, and MgO, and the content of the material for causing grain boundary segregation in the first magnetic layer 106 is decreased from the substrate side to the second magnetic layer 107 side.

### TECHNICAL FIELD

The present invention relates to a thermally assisted magnetic recording medium used in a hard disc device (HDD), etc. and a magnetic recording and reproducing device using the same.

Priority is claimed on Japanese Patent Application No. 2010-014271 filed Jan. 26, 2010, the contents of which are incorporated herein by reference.

### BACKGROUND ART

Recently, thermally assisted recording, in which a magnetic recording medium is irradiated with near-field light, etc. to partially heat the surface of the magnetic recording medium, and the coercive force is reduced to write information, has been focused on as a next-generation recording system which can achieve high surface recording density such as 1 Tbit/inch.

When such a thermally assisted recording system is used, it is possible to easily write even a magnetic recording medium having a coercive force at room temperature of several dozen kOe by recording the magnetic field of a current head. Therefore, it is possible to form a magnetic layer using a material having high magnetocrystalline anisotropy (Ku), for example, at 10⁶ J/m³ level, which can be used in a magnetic layer of the thermally assisted magnetic recording medium. Due to this, it is possible to make the diameter of magnetic particles finer, such as 6 nm or less, while maintaining high thermal stability.

For example, as the high Ku material, FePt alloys (Ku: about 7×10⁶ J/m³) having a crystal lattice structure of L1₀ type, CoPt alloys (Ku: about 5×10⁶ J/m³) having a crystal lattice structure of L1₀ type, etc. are well-known. In addition, CoPt alloys having a crystal lattice structure of L1₁ type also have high Ku, such as 10⁶ erg/cc level. Furthermore, it is also well-known that rare earth alloys such as CoSm alloys, and NdFeB alloys have high Ku, in addition to these alloys. Furthermore, since a Co/Pt multilayer, a Co/Pd multilayer, etc. have a high anisotropy field (Hk) while the Curie temperature thereof is relatively easily controlled, these multilayer films have been examined as the magnetic layer of the thermally assisted recording medium.

Since the magnetic layer of the current perpendicular magnetic recording medium has a granular structure, in which a Co alloy is divided with oxides such as SiO₂, and the magnetic exchange bonding energy between Co crystal grains decreases due to the oxides, the perpendicular magnetic recording medium has a high SN ratio. However, a magnetic layer having a granular structure generally has a high magnetization switching field (Hsw) distribution. In order to achieve high surface recording density, it is necessary to decrease the Hsw distribution of the magnetic recording medium. Therefore, a magnetic layer which does not contain oxides and has magnetically continuous bonding in the film surface direction is formed on the magnetic layer having a granular structure. This is for introducing uniform exchange bonding between the magnetic particles in the magnetic layer having a granular structure. Thereby, the Hsw distribution can be reduced. The continuous film having no oxides is also called a Cap layer, and a layered structure including the magnetic layer having a granular structure and the Cap layer is also called a CGC (Coupled Granular and Continuous) structure.

In the thermally assisted magnetic recording medium, it is preferable that the magnetic layer be made of a material having high Ku, such as FePt alloys having a L1₀ type crystal lattice structure. However, even when such a material is used to form the magnetic layer, it is necessary to add oxides such as SiO₂, TiO₂, Cr₂O₃, Al₂O₃, Ta₂O₅, ZrO₂, Y₂O₃, CeO₂, MnO, TiO, ZnO, and MgO, and C to make the diameter of the magnetic particles fine and to reduce exchange bonding between the magnetic particles, as a material for causing grain boundary segregation (referred to as grain boundary segregation-material below) in the magnetic layer. In order to obtain fine magnetic particles having a diameter of 6 nm or less and sufficient reduction of exchange bonding, the content of the grain boundary segregation-material is required to be 30% by volume or more, and preferably 40% by volume or more.

Non-Patent Document 1 below discloses that the diameter of the magnetic particles can be reduced to 5.5 nm by adding 50 at % of C in a FePt alloy.

Non-Patent Document 2 below discloses that the diameter of the magnetic particles can be reduced to 5 nm by adding 20% by volume of TiO₂ in a FePt alloy.

Non-Patent Document 3 below discloses that the diameter of the magnetic particles can be reduced to 2.9 nm by adding 50% by volume of SiO₂ in a FePt alloy.

However, in these cases, the crystal grains of the FePt alloy have a spherical structure which is divided in the perpendicular direction to the film surface, and not a columnar structure.

### PRIOR DOCUMENTS

| | |
|---|---|
| [Non-Patent Document 1] | Appl. Phys. Express, 101301, 2008 |
| [Non-Patent Document 2] | J. Appl. Phys. 104, 023904, 2008 |
| [Non-Patent Document 3] | IEEE. Trans. Magn., vol. 45, 839-844, 2009 |

### SUMMARY OF INVENTION

### Technical Problem

As explained above, in order to achieve a high SN ratio in the medium, it is necessary to make the diameter of the magnetic particles fine while reducing the Hsw distribution. Since the Hsw distribution has a correlation with the coercive force distribution (ΔHc/Hc), the Hsw distribution can be generally evaluated by evaluating the ΔHc/Hc. In the thermally assisted magnetic recording medium, it is necessary to heat the magnetic layer to 200 to 400° C. during recording. The coercive force distribution in this temperature range is extremely higher than that of the medium having a granular structure. Therefore, reduction of the coercive force distribution is an extremely serious problem to be solved to achieve high density of the thermally assisted magnetic recording medium.

In the current medium having a granular structure, the coercive force distribution is reduced by using a CGC structure or an ECC structure in which a magnetic layer having a continuous structure is formed on a magnetic layer having a granular structure. However, as a result of examination by the present inventors, it was confirmed that the coercive force distribution could not be reduced by forming a continuous film such as a CoCrPt alloy film on the magnetic layer having a granular structure containing a FePt alloy and a grain boundary segregation-material, such as SiO₂. The reasons are shown below.

In order to make the diameter of the magnetic particles 5 to 6 nm or less, it is necessary to add about 30% by volume or more of a grain boundary segregation-material, such as SiO₂. However, when 30% by volume or more of a grain boundary segregation-material is added, the magnetic layer does not have a columnar structure which grows continuously in the perpendicular direction to the substrate surface. This is because, when an excess amount of a grain boundary segregation-material is added, the grain boundary segregation-material is deposited at not only the magnetic boundary but also at the surface of the magnetic crystal grains.

Non-Patent Document 3 discloses that as a result of TEM observation of the cross-section of the FePt magnetic layer containing 15% by volume of C, it was confirmed that spherical FePt grows discontinuously on the columnar FePt crystal grains. In this case, when the Cap layer having a continuous structure is formed on the magnetic layer having a granular structure, it is impossible to introduce exchange bonding between the FePt magnetic particles. In addition, since the spherical magnetic crystal grains formed on the upper portion of the magnetic layer are magnetically isolated, and have a small switching field, this greatly contributes to increasing the coercive force distribution. Therefore, in order to reduce the coercive force distribution, it is necessary to prevent the generation of spherical crystal grains and form a columnar structure in which crystal grains grow continuously in the perpendicular direction to the substrate surface in the magnetic layer.

In consideration of the above-described problems, it is an object of the present invention to provide a thermally assisted magnetic recording medium having 1 Tbit/inch² or more of the surface recording density, and a magnetic recording and reproducing device having a high capacity including the thermally assisted magnetic recording medium.

### Solution to Problem

In order to attain the foregoing objects, the present provides the following inventions.

(1) A thermally assisted magnetic recording medium having a structure in which a first magnetic layer and a second magnetic layer are formed on a substrate in this order, wherein the first magnetic layer has a granular structure containing a FePt alloy having a L1₀ crystal lattice structure, a CoPt alloy having a L1₀ crystal lattice structure or a CoPt alloy having a L1₁ crystal lattice structure, and at least one material for causing grain boundary segregation selected from the group consisting of SiO₂, TiO₂, Cr₂O₃, Al₂O₃, Ta₂O₅, ZrO₂, Y₂O₃, CeO₂, MnO, TiO, ZnO, and MgO, and the content of the material for causing grain boundary segregation in the first magnetic layer is decreased from the substrate side to the second magnetic layer side.
(2) The thermally assisted magnetic recording medium according to (1), wherein the first magnetic layer includes a fixed-content area of which the content of the material for causing grain boundary segregation is fixed from the substrate side to the second magnetic layer side and a decreased-content area of which the content of the material for causing grain boundary segregation is decreased from the substrate side to the second magnetic layer side.
(3) The thermally assisted magnetic recording medium according to (2), wherein the percentage of the thickness of fixed-content area in the total thickness of the first magnetic layer is 70% or less.
(4) The thermally assisted magnetic recording medium according to (2) or (3), wherein the content of the material for causing grain boundary segregation in the fixed-content area is 30% by volume or more.
(5) The thermally assisted magnetic recording medium according to any one of (1) to (4), wherein the second magnetic layer is made of an amorphous alloy containing Co and at least one of Zr, Ta, Nb, B, and Si.
(6) The thermally assisted magnetic recording medium according to any one of (1) to (4), wherein the second magnetic layer is made of an amorphous alloy containing Fe and at least one of Zr, Ta, Nb, B, and Si.
(7) The thermally assisted magnetic recording medium according to any one of (1) to (4), wherein the second magnetic layer is made of an alloy containing Fe and having a BCC crystal lattice structure or a FCC crystal lattice structure.
(8) The thermally assisted magnetic recording medium according to any one of (1) to (4), wherein the second magnetic layer is made of an alloy containing Co and having a HCP crystal lattice structure.
(9) The thermally assisted magnetic recording medium according to any one of (1) to (4), wherein a magnetocrystalline anisotropy constant of the second magnetic layer is smaller than a magnetocrystalline anisotropy constant of the first magnetic layer.
(10) A magnetic recording and reproducing device including:

the thermally assisted magnetic recording medium according to any one of (1) to (9);

a medium driving portion for driving the thermally assisted magnetic recording medium in a recording direction;

a magnetic head which includes a laser generation portion for heating the thermally assisted magnetic recording medium and a waveguide for introducing a laser generated in the laser generation portion to an edge portion, and which records and reproduces the thermally assisted magnetic recording medium;

a head movement device for moving the magnetic head relatively to the thermally assisted magnetic recording medium; and

a recording and reproducing signal-processing device for inputting a signal to the magnetic head and reproducing an output signal from the magnetic head.

### Advantageous Effects of Invention

According to the present invention, it is possible to provide a thermally assisted magnetic recording medium having 1 Tbit/inch² or more of the surface recording density, and a magnetic recording and reproducing device having a high capacity including the thermally assisted magnetic recording medium.

### BRIEF DESCRIPTION OF DRAWINGS

FIG. 1 is a sectional view showing a layer structure of the thermally assisted magnetic recording medium produced in Example 1.

FIG. 2 is a graph showing a content percentage of C in the first magnetic layer in Example 1.

FIG. 3 is a graph showing a content percentage of C in the first magnetic layer in Example 1.

FIG. 4 is a graph showing a content percentage of C in the first magnetic layer in Example 1.

FIG. 5 is a graph showing a content percentage of C in the first magnetic layer as Comparative Example to Example 1.

FIG. 6 is a graph showing a relationship between the heating temperature and Hc in the first magnetic layer in Example 1.

FIG. 7 is a graph showing a relationship between the heating temperature and ΔHc/Hc in the first magnetic layer in Example 1.

FIG. 8 is a graph showing a relationship between Hc and ΔHc/Hc in the first magnetic layer in Example 1.

FIG. 9 is a graph showing a relationship between Hc and ΔHc/Hc in the second magnetic layer in Example 1.

FIG. 10 is a sectional view showing a layer structure of the thermally assisted magnetic recording medium produced in Example 2.

FIG. 11 is a graph showing a content percentage of TiO₂ in the first magnetic layer in Example 2.

FIG. 12 is a graph showing a content percentage of TiO₂ in the first magnetic layer in Example 2.

FIG. 13 is a graph showing a content percentage of TiO₂ in the first magnetic layer in Example 2.

FIG. 14 is a graph showing a content percentage of TiO₂ in the first magnetic layer in Example 2.

FIG. 15 is a graph showing a content percentage of TiO₂ in the first magnetic layer in Example 2.

FIG. 16 is a graph showing a content percentage of TiO₂ in the first magnetic layer in Example 2.

FIG. 17 is a sectional view showing a layer structure of the thermally assisted magnetic recording medium produced in Example 3.

FIG. 18 is a perspective view showing the magnetic recording and reproducing device used in Example 4.

FIG. 19 is a sectional view showing schematically the magnetic head in the magnetic recording and reproducing device shown in FIG. 18.

### DESCRIPTION OF EMBODIMENTS

A thermally assisted magnetic recording medium and a magnetic recording and reproducing device according to the present invention are explained in detail referring to figures below.

Moreover, figures used in the following embodiments are used for explaining the construction of the embodiments according to the present invention. For convenience, the characteristic part may be enlarged. The proportion of each element shown in the figures may be different from the actual proportion.

The thermally assisted magnetic recording medium according to the present invention has a structure in which a first magnetic layer and a second magnetic layer are formed on a substrate in this order, wherein the first magnetic layer has a granular structure containing a FePt alloy having a L1₀ crystal lattice structure, a CoPt alloy having a L1₀ crystal lattice structure or a CoPt alloy having a L1₀ crystal lattice structure, and at least one of grain boundary segregation-material selected from the group consisting of SiO₂, TiO₂, Cr₂O₃, Al₂O₃, Ta₂O₅, ZrO₂, Y₂O₃, CeO₂, MnO, TiO, ZnO, and MgO, and the content of the grain boundary segregation-material in the first magnetic layer is decreased from the substrate side to the second magnetic layer side.

As the substrate, crystalline glass substrates having excellent heat resistance, chemically strengthened glass, or silicon (Si) substrates having high thermal conductivity can be used.

The first magnetic layer has a granular structure in which the grain boundary segregation-material (non-magnetic material), such as SiO₂, TiO₂, Cr₂O₃, Al₂O₃, Ta₂O₅, ZrO₂, Y₂O₃, CeO₂, MnO, TiO, ZnO, and MgO, and the mixture thereof are segregated on the grain boundaries of the crystal grains (magnetic particles) of a FePt alloy having a L1₀ crystal lattice structure, a CoPt alloy having a L1₀ crystal lattice structure or a CoPt alloy having a L1₁ crystal lattice structure.

In the present invention, the content (concentration) of the grain boundary segregation-material in the first magnetic layer is decreased from the substrate side to the second magnetic layer side. Thereby, it is possible to prevent excess grain boundary segregation-material being deposited on the crystal grains of the FePt alloy or the CoPt alloy, and the grain growth is divided in the perpendicular direction. In addition, it is also possible to form crystal grains of the FePt alloy or the CoPt alloy which have a small diameter, and grow them continuously in the perpendicular direction of the surface of the substrate.

In order to decrease the content of the grain boundary segregation-material in the first magnetic layer, for example, during co-sputtering using a FePt target and a grain boundary segregation-material target, the percentage of the discharge power to the grain boundary segregation-material target is lowered continuously or in a step-by-step manner relative to the discharge power to the FePt target. Due to this, it is possible to produce the first magnetic layer including plural layers (that is, multilayer) in which the content of the grain boundary segregation-material is decreased continuously or in a step-by-step manner.

In addition, it is also possible to form the first magnetic layer including plural layers (that is, multilayer) in which the content of the grain boundary segregation-material is decreased in a step-by-step manner by using a composite target which contains FePt and the grain boundary segregation-material and has the different content of the grain boundary segregation-material and making films in a multistep manner in ascending order of the content of the grain boundary segregation-material.

The first magnetic layer may include a fixed-content (concentration) area of which the content (concentration) of the grain boundary segregation-material is fixed from the substrate side to the second magnetic layer side and a decreased-content (concentration) area of which the content (concentration) of the grain boundary segregation-material is decreased from the substrate side to the second magnetic layer side. In other words, the content of the grain boundary segregation-material may be decreased at the initial stage or halfway stage in sputtering to form a film.

For example, when the thickness of the first magnetic layer is 10 nm, it is possible to fix the content of the grain boundary segregation-material until the thickness of the produced layer is 5 nm, and decrease the content in a step-by-step manner after that. In this case, it is preferable that the percentage of the thickness of the fixed-content area be 70% or less relative to the total thickness of the first magnetic layer. When the percentage exceeds 70%, columnar growth of the crystal grains may be prevented by excess grain boundary segregation-material, and it is not preferable.

In addition, the content of grain boundary segregation-material is preferably 30% by volume or more, and more preferably 40% by volume or more in the fixed content area of the grain boundary segregation-material. When the content of the grain boundary segregation-material is 30% by volume or more, the diameter of the crystal grains of the FePt alloy or the CoPt alloy can be smaller, that is, reduced to 6 nm or less, and at the same time, the width of the grain boundaries can be 1 nm or more, and it is possible to sufficiently reduce the exchange bonding between the magnetic particles.

The thickness of the first magnetic layer is preferably in a range from 1 nm to 20 nm. When the thickness is less than 1 nm, sufficient reproducing power cannot be obtained, and it is not preferable. In contrast, when the thickness exceeds 20 nm, the crystal grains become extremely large, and it is not preferable.

In order to introduce the exchange bonding in the FePt crystal grains or the CoPt crystal grains in the first magnetic layer, the second magnetic layer is preferably a continuous layer which is magnetically bonded. Due to this, the coercive force distribution can be effectively reduced. In addition, the second magnetic layer preferably has a magnetocrystalline anisotropy which is lower than that of the first magnetic layer. Due to this, it is possible to assist the magnetization reversal in the first magnetic layer.

The second magnetic layer may be formed using an amorphous alloy or material having a fine crystalline structure which is similar to the amorphous alloy. Specifically, the second magnetic layer may be made of an alloy containing Co and at least one of Zr, Ta, Nb, B, and Si, or an alloy containing Fe and at least one of Zr, Ta, Nb, B, and Si. When the second magnetic layer is made of the alloy, flatness of the surface of the thermally assisted magnetic recording medium can be improved, and thereby floating properties of the magnetic head can also be improved.

In addition, when the first magnetic layer is formed by using the FePt alloy having a L1₀ crystal lattice structure, the second magnetic layer can be made of an alloy containing Fe as a main component and having a BCC crystal lattice structure or a FCC crystal lattice structure, specifically, FeNi, FeCr, Fey, FePt, etc. These alloys epitaxially grow on the FePt alloy having a L1₀ crystal lattice structure. Therefore, higher Hc can be obtained, compared with a case in which the second magnetic layer is made of an amorphous alloy.

On the other hand, when the first magnetic layer is formed by using the CoPt alloy having a L1₁ crystal lattice structure, the second magnetic layer can be made of a Co alloy having a HCP structure, specifically, CoCr, CoCrPt, CoPt, CoCrTa, CoCrB, CoCrPtTa, CoCrPtB, CoCrPtTaB, etc. These alloys epitaxially grow on the CoPt alloy having a L1₁ crystal lattice structure. Therefore, higher Hc can be obtained, compared with a case in which the second magnetic layer is made of an amorphous alloy.

The thickness of the second magnetic layer is preferably in a range from 0.5 nm to 10 nm. When the thickness of the second magnetic layer is less than 0.5 nm, the flatness of the surface is decreased, which is not preferable. In contrast, when the thickness of the second magnetic layer exceeds 10 nm, the space between the magnetic head and the thermally assisted magnetic recording medium is too large, which is not preferable.

In the thermally assisted magnetic recording medium according to the present invention, for the purpose of controlling the orientation of the first magnetic layer and the diameter of crystal grains, and improving adhesion, it is possible to form plural underlayers under the first magnetic layer.

For example, when the first magnetic layer is made of a FePt alloy having a L1₀ crystal lattice structure, in order to make the FePt alloy have (001) orientation, an underlayer made of (100) orientated MgO is preferably formed. In order to make MgO have (100) orientation, for example, a Ta layer is formed on the substrate, and a MgO layer is formed on the Ta layer. In addition to the Ta layer, it is possible to make MgO have (100) orientation by making the MgO layer on an amorphous alloy layer such as an Ni-40 at % Ta layer and Cr-50 at % Ti layer.

When a Cr layer is formed on the substrate which is heated to 150° C. or more, it is possible to make the Cr layer have (100) orientation. Furthermore, it is also possible to make the MgO have (100) orientation by making the MgO layer on the (100) orientated Cr layer.

Moreover, when the Cr underlayer which is (100) orientated is used, the first magnetic layer may be formed directly on the Cr layer without intervening the MgO layer. Thereby, it is possible to form a FePt alloy having a L1₀ crystal lattice structure in the first magnetic layer have (001) orientation.

Moreover, when the first magnetic layer is made of a CoPt alloy having a L1₁ crystal lattice structure, it is preferable to make the CoPt alloy have (111) orientation. In this case, for example, a Pt layer which is (111) orientated can be used as the underlayer. However, any underlayers can be used without limitations as long as they can form the CoPt alloy having a L1₁ crystal lattice structure have (111) orientation.

In addition, it is also possible to form a soft magnetic underlayer under the first magnetic layer in the thermally assisted magnetic recording medium according to the present invention. Examples of the soft magnetic underlayer include layers made of CoFeTaZr alloy, CoFeTaSi alloy, CoFeTaB alloy, or CoTaZr alloy which are antiferromagnetically bonded to each other via a Ru layer. In addition, it is also possible to use a monolayer made of the alloy as the soft magnetic underlayer.

In addition, it is also possible to form a heat sink layer between the substrate and the magnetic layer to rapidly cool the magnetic layer after recording which is heated by near-field light during recording in the thermally assisted magnetic recording medium according to the present invention. Moreover, the heat sink layer can be formed at any position as long as it is between the substrate and the magnetic layer. The heat sink layer can be formed by a material having high thermal conductivity such as Cu, Ag, Al, and material containing Cu, Ag, or Al as a main component.

As explained above, the content of the grain boundary segregation-material in the first magnetic layer is decreased from the substrate side to the second magnetic layer side in the thermally assisted magnetic recording medium according to the present invention. Thereby, it is possible to prevent excess grain boundary segregation-material being deposited on the crystal grains of the FePt alloy or the CoPt alloy and the grain growth in the perpendicular direction is divided. In addition, it is also possible to form crystal grains of the FePt alloy or the CoPt alloy which have a small diameter, and grow them continuously in the perpendicular direction of the surface of the substrate.

According to the thermally assisted magnetic recording medium of the present invention, the coercive force distribution (ΔHc/Hc) can be reduced. Therefore, it is possible to produce a thermally assisted magnetic recording medium having 1 Tbit/inch² or more of the surface recording density, and a magnetic recording and reproducing device having a high capacity including the thermally assisted magnetic recording medium.

### EXAMPLES

The present embodiment will be described in more detail below referring to the following Examples, although the present embodiment is in no way limited by the following Examples. The constitution of the present invention can be changed as long as the change to the constitution is within the scope of the present invention.

### Example 1

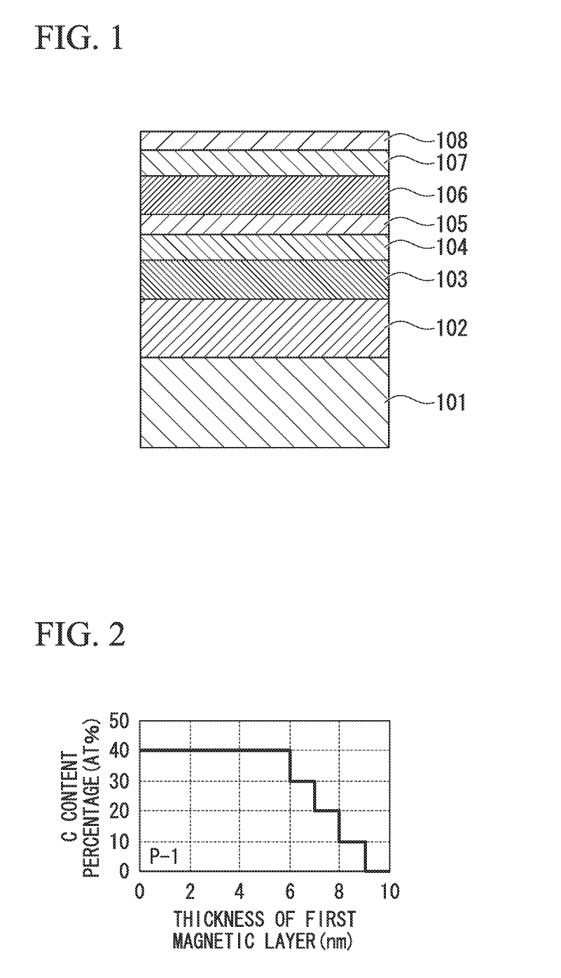

One example of the layer structure of a thermally assisted magnetic recording medium produced in Example 1 is shown in FIG. 1.

The thermally assisted magnetic recording medium in the Example 1 was formed by forming an underlayer 102, which is made of a Cr-50 at % Ti alloy and has a thickness of 100 nm, and a soft magnetic mono underlayer 103, which is made of a Co-27 at % Fe-5 at % Zr-5 at % B alloy and has a thickness of 30 nm, on a glass substrate 101 in this order; then, the glass substrate 101 was heated to 250° C.; an underlayer 104, which is made of Cr and has a thickness of 10 nm, and an underlayer 105, which is made of MgO and has a thickness of 5 nm, were formed in this order on the soft magnetic mono underlayer 103; the glass substrate 101 was heated to 450° C.; and a first magnetic layer 106, which is made of (Fe-55 at % Pt)—C alloy and has a thickness of 10 nm, a second magnetic layer 107, which is made of a Co-26 at % Fe-10 at % Ta-2 at % B alloy and has a thickness of 3 nm, and a protective layer 108, which is made of C and has a thickness of 3 nm, were formed in this order.

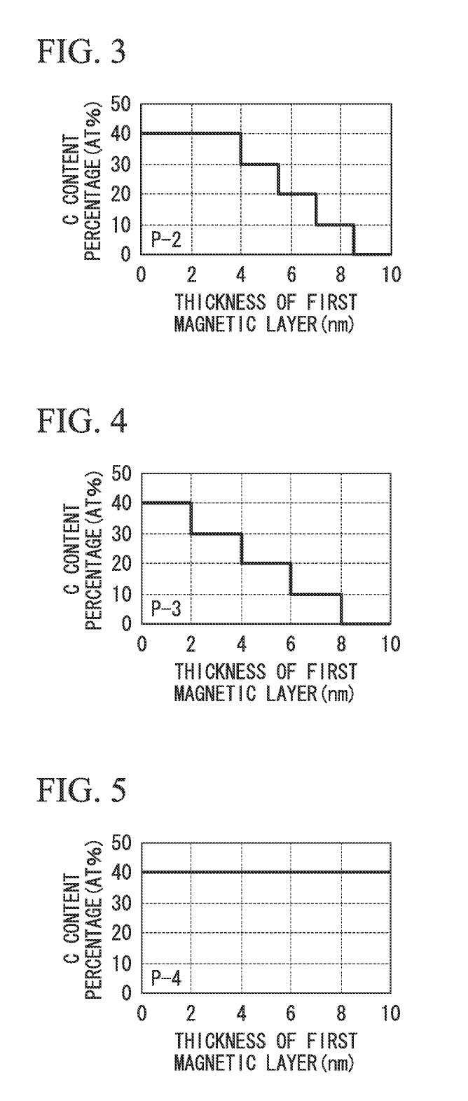

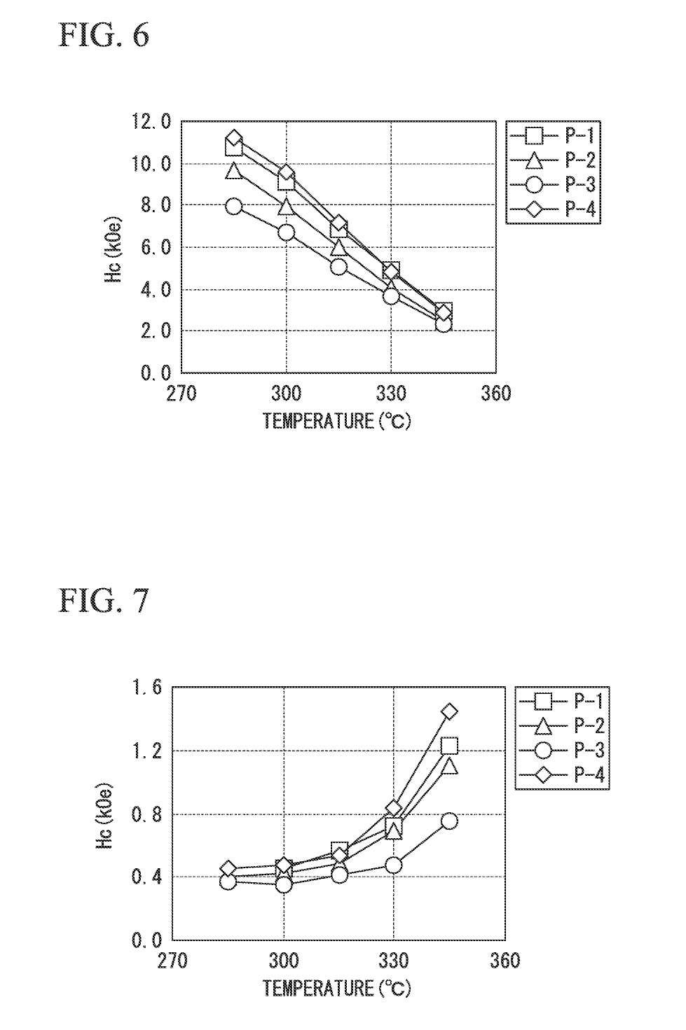

The first magnetic layer 106 was formed by sputtering a Fe-55 at % Pt target and a C target at the same time. Moreover, the percentage of the discharge power to the C target relative to the discharge power to the Fe-55 at % Pt target was lowered in a step-by-step manner. Thereby, the content of C (the grain boundary segregation-material) in the first magnetic layer 106 was decreased in a step-by-step manner in the thickness direction. Through these processes, the thermally assisted magnetic recording media, which have three C concentration profiles (P-1 to P-3) as shown in FIGS. 2 to 4, were produced. Moreover, a thermally assisted magnetic recording medium including a first magnetic layer, in which the content of C is fixed to 40 at % and which has a C concentration profile (P-4) as shown in FIG. 5, was also produced as Comparative Example.

As a result of X-ray diffraction analysis of the thermally assisted magnetic recording media having the four different C concentration profiles (P-1 to P-4), a strong L1₀-FePt (001) diffraction peak was observed in all thermally assisted magnetic recording media. In addition, a mixing peak of L1₀-FePt (002) diffraction peak and a FCC-Fe (002) diffraction peak was also observed. The integral intensity ratio of the former diffraction peak relative to the latter mixing peak was 1.7. Based on this result, it was confirmed that L1₀ type FePt alloy crystal grains having a high degree of order were formed.

The variation of the coercive force (Hc) and the coercive force distribution (ΔHc/Hc) when the thermally assisted magnetic recording media having the four different C concentration profiles (P-1 to P-4) were heated to 280° C. to 360° C. are shown in FIGS. 6 and 7 respectively. Moreover, ΔHc/Hc was measured according to the method disclosed in IEE Trans. Magn., vol. 27, pp 4975-4977, 1991. Specifically, ΔHc/Hc was obtained by measuring the magnetic field when the magnetization is 50% of the saturated magnetization in the major loop and the minor loop, and assuming Hc distribution is Gaussian distribution based on the difference between the magnetic field in the major loop and the minor loop.

As shown in FIGS. 6 and 7, Hc decreases and ΔHc/Hc increases as the temperature increases in all thermally assisted magnetic recording media having the four different C concentration profiles (P-1 to P-4). When the thermally assisted magnetic recording medium is recorded, the thermally assisted magnetic recording medium is partially heated, and Hc at the heated portion is sufficiently decreased. Therefore, this result shows that ΔHc/Hc was remarkably increased during recording compared with ΔHc/Hc at room temperature.

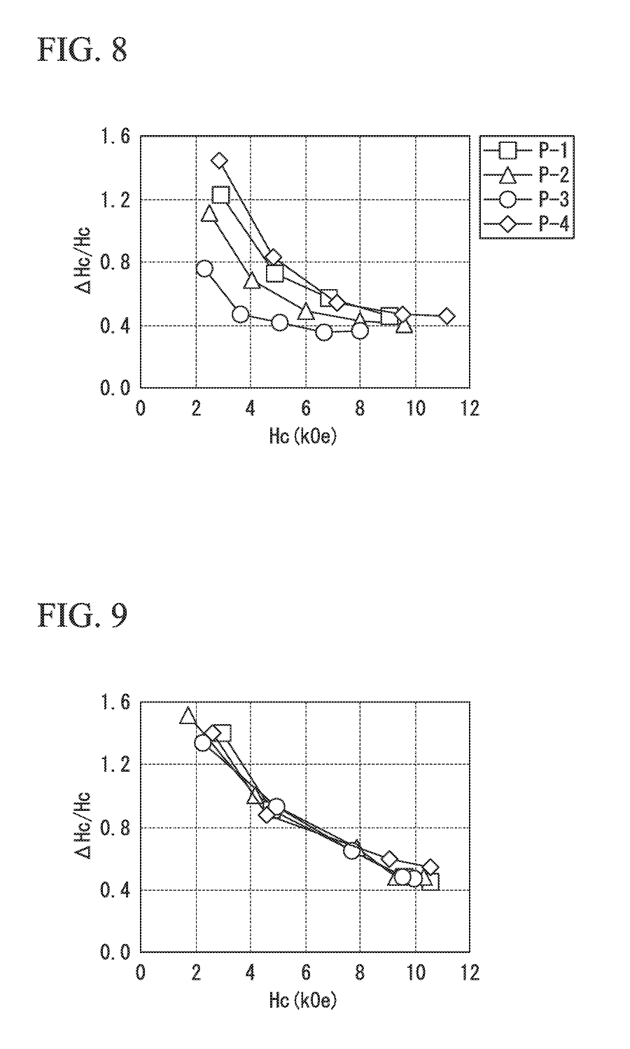

When ΔHc/Hc is compared, it is necessary to make uniform Hc. Therefore, ΔHc/Hc shown in FIG. 7 is calculated based on Hc shown in FIG. 6, the ΔHc/Hc calculated is shown in FIG. 8.

As shown in FIG. 8, when Hc is 5 kOe, ΔHc/Hc of the thermally assisted magnetic recording media having C concentration profiles P-1 to P-3 of Example is about 0.1 to 0.4 less than that of the Comparative thermally assisted magnetic recording medium having a C concentration profile P-4. In addition, ΔHc/Hc decreases in P-1, P-2, and P-3 in this order. From this result, it was confirmed that the coercive force distribution is prevented as the area, at which the C content is lower, expands.

Then, the thermally assisted magnetic recording media in which the second magnetic layer 107 is not formed on the first magnetic layer 106, were produced as a Comparative Example. The Comparative thermally assisted magnetic recording media have the same four different C concentration profiles (P-1 to P-4) as those of the thermally assisted magnetic recording medium explained above. In addition, the Comparative thermally assisted magnetic recording media were produced by the same process as that of the thermally assisted magnetic recording medium explained above. The relationship between the coercive force (Hc) and the coercive force distribution (ΔHc/Hc) when these thermally assisted magnetic recording media were heated to 280° C. to 360° C. is shown in FIG. 9.

As shown in FIG. 9, the plots show the relationship between Hc and ΔHc/Hc on the same line without relation to the C concentration profiles. When the Hc is 5 kOe, ΔHc/Hc is extremely larger such as about 0.8 to 0.9.

Based on these results, it was confirmed that the coercive force distribution cannot be improved even when the C concentration percentage in the first magnetic layer 106 is decreased in a step-by-step manner and the second magnetic layer 107 is not formed. That is, it was confirmed that the coercive force distribution can be reduced by decreasing the C content in the first magnetic layer 106 in a step-by-step manner and forming the second magnetic layer 107 on the first magnetic layer 106.

### Example 2

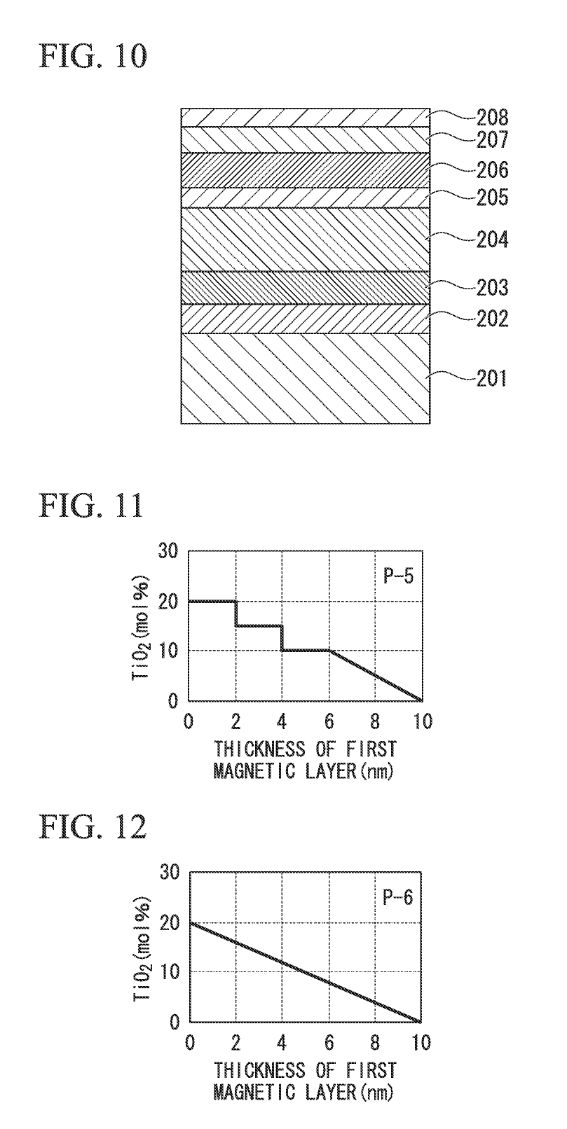

One example of the layer structure of a thermally assisted magnetic recording medium produced in Example 2 is shown in FIG. 10.

The thermally assisted magnetic recording medium in the Example 2 was formed by forming an underlayer 202, which is made of a Ni-40 at % Ta alloy and has a thickness of 30 nm on a glass substrate 201; the glass substrate 201 was heated to 280° C.; an underlayer 203, which is made of Cr and has a thickness of 10 nm was formed thereon; a heat sink layer 204, which is made of Ag and has a thickness of 100 nm, and an underlayer 205, which is made of MgO and has a thickness of 10 nm, were formed in this order; then the glass substrate 201 was heated to 420° C.; after that, a first magnetic layer 206, which is made of (Fe-55 at % Pt)—TiO₂ alloy and has a thickness of 10 nm, a second magnetic layer 207, which has a thickness of 2 to 4 nm, and a protective layer 208, which is made of C and has a thickness of 3.5 nm, were formed in this order.

Moreover, the combination between the concentration profile of TiO₂ (grain boundary segregation-material) in the first magnetic layer 206 and the second magnetic layer 207 were changed as shown in Table 1 below to produce the thermally assisted magnetic recording medium No. 2-1 to No. 2-12. Moreover, a thermally assisted magnetic recording medium (No. 2-13) including a first magnetic layer, in which the content of TiO₂ is fixed to 20 at %, was also produced as Comparative Example.

TABLE 1

| | Concentration | | ΔHc/ | |
|---|---|---|---|---|
| No. | Profile of TiO₂ | Second magnetic layer | Hc | Note |
| 2-1 | P-5 | Co-15 at % Ta-5 at % Zr | 0.40 | Example |
| 2-2 | P-5 | Co-10 at % Ta-10 at % B | 0.32 | Example |
| 2-3 | P-6 | Fe-10 at % Ta-3 at % C | 0.45 | Example |
| 2-4 | P-6 | Fe-30 at % Co-5 at % Si | 0.55 | Example |
| 2-5 | P-7 | Fe-20 at % Co-5 at % | 0.51 | Example |
| | | Ta-2 at % B | | |
| 2-6 | P-7 | Co-5 at % Ta-5 at % | 0.39 | Example |
| | | Zr-2 at % B | | |
| 2-7 | P-8 | Co-30 at % Fe-5 at % Nb | 0.51 | Example |
| 2-8 | P-8 | Fe-20 at % Ni-5 at % | 0.43 | Example |
| | | Ta-5 at % Ti | | |
| 2-9 | P-9 | Co-16 at % Cr-8 at % | 0.59 | Example |
| | | Pt-2 at % B | | |
| 2-10 | P-9 | Co-10 at % Cr-5 at % | 0.52 | Example |
| | | Ta-3 at % B | | |
| 2-11 | P-10 | Co-12 at % Ti-5 at % B | 0.47 | Example |
| 2-12 | P-10 | Co-10 at % Ta-10 at % Ti | 0.44 | Example |
| 2-13 | Constant at | Co-15 at % Ta-5 at % Zr | 0.93 | Compar- |
| | 20% by mol | | | ative |
| | | | | Example |

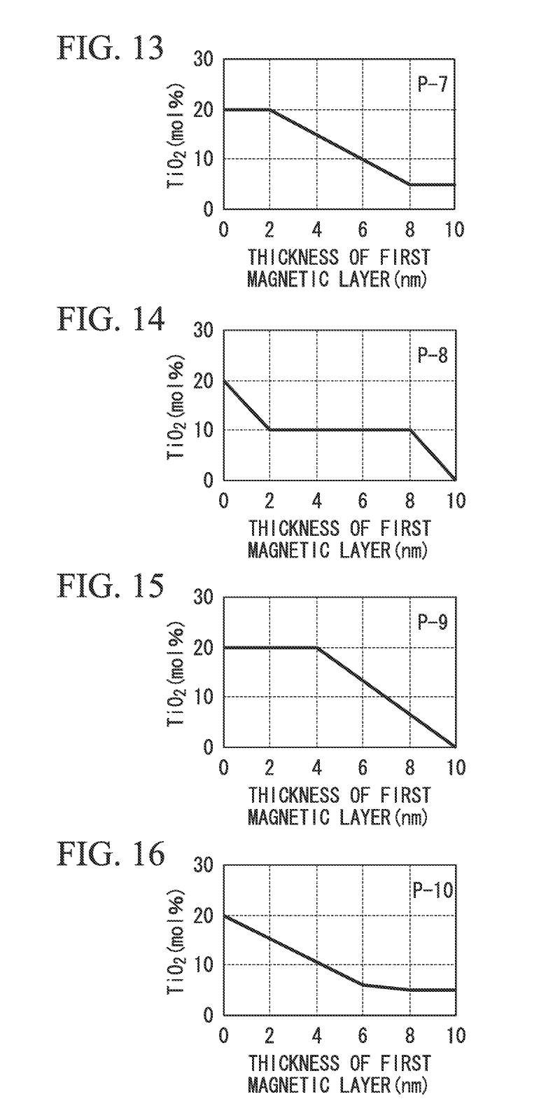

The first magnetic layer 206 was formed by sputtering a Fe-55 at % Pt target and a TiO₂ target at the same time. Moreover, the percentage of the discharge power of the TiO₂ target relative to the discharge power to the Fe-55 at % Pt target was lowered continuously or in a step-by-step manner. Thereby, the thermally assisted magnetic recording media which have the six different TiO₂ concentration profiles (P-5 to P-10) shown in FIGS. 11 to 16 were produced.

As a result of X-ray diffraction analysis of the thermally assisted magnetic recording media (No. 2-1 to No. 2-13), a strong BCC (200) diffraction peak was observed in the Cr underlayer 203 and the Ag heat sink layer 204 in all thermally assisted magnetic recording media. In addition, a strong L1₀ FePt (001) diffraction peak was observed in the first magnetic layer 206. Furthermore, a mixed peak of a L1₀-FePt (002) diffraction peak and a FCC-Fe (200) diffraction peak was also observed in the first magnetic layer 206. The integral intensity ratio of the former diffraction peak relative to the latter mixing peak was 1.6 in the first magnetic layer 206. Based on this result, it was confirmed that L1₀ type FePt alloy crystal grains having a high degree of order were formed.

Next, as a result of a planar TEM analysis of the thermally assisted magnetic recording media No. 2-1 to No. 2-12, it was confirmed that all the first magnetic layers 206 have a granular structure in which the FePt alloy crystal grains are covered with TiO₂. In addition, the average grain size of the FePt alloy crystal grains was about 5 to 6 nm.

Next, as a result of a cross-sectional TEM analysis of the thermally assisted magnetic recording media No. 2-1 to No. 2-12, it was confirmed that all the first magnetic layers 206 have a columnar structure in which the FePt alloy crystal grains grow in the perpendicular direction relative to the surface of the substrate. In contrast, as a results of a cross-sectional TEM analysis of the Comparative thermally assisted magnetic recording medium No. 2-13, it was confirmed that the first magnetic layer 206 had a two layer-structure including a layer containing columnar FePt crystal grains and another layer containing spherical FePt crystal grains formed on the layer containing columnar FePt crystal grains.

In addition, a clear lattice fringe was not observed in the alloy constituting the second magnetic layer 207 in the thermally assisted magnetic recording media No. 2-1 to No. 2-13. Thereby, it is clear that all the second magnetic layer 207 had an amorphous structure.

Then, the coercive force (Hc) and the coercive force distribution (ΔHc/Hc) when the thermally assisted magnetic recording media No. 2-1 to No. 2-13 were heated to 280° C. to 360° C. were measured, and the ΔHc/Hc when the Hc was 5 kOe was estimated. These results are also shown in Table 1 above.

As shown in Table 1 above, ΔHc/Hc of the thermally assisted magnetic recording media No 2-1 to No. 2-12 in Example, when the Hc was 5 kOe, was lower 0.3 to 0.6 than that of the Comparative thermally assisted magnetic recording medium No. 2-13. The reason for this result was believed to be because the thermally assisted magnetic recording medium No. 2-13 has the first magnetic layer 206 which has a two layer-structure including a layer containing columnar FePt crystal grains and another layer containing spherical FePt crystal grains formed on the layer containing columnar FePt crystal grains, but the first magnetic layer 206 of the thermally assisted magnetic recording media No. 2-1 to No. 2-12 has a columnar structure in which the FePt alloy crystal grains grow in the perpendicular direction relative to the surface of the substrate.

Based on these results, it is clear that the first magnetic layer 206 has a columnar structure in which the crystal grains grow in the perpendicular direction relative to the surface of the substrate by decreasing the content of TiO₂ in the first magnetic layer 206 in a step-by-step manner, and thereby the coercive force distribution could be decreased.

In addition, it is possible to further decrease the ΔHc/Hc by increasing the thickness of the second magnetic layer 207, or increasing the saturated magnetic flux density (Bs). However, since the medium noise increases when the exchange bonding between the FePt crystal grains in the first magnetic layer 206 is increased, it is necessary to adjust the thickness and Bs in the second magnetic layer 207 so as to prevent the increase of the medium noise in both cases.

In addition to the alloys used in the second magnetic layer 207, which are explained above, alloys having a BCC crystal lattice structure or FCC crystal lattice structure, such as FeNi, FeCr, FeV, and FePt can also be used.

### Example 3)

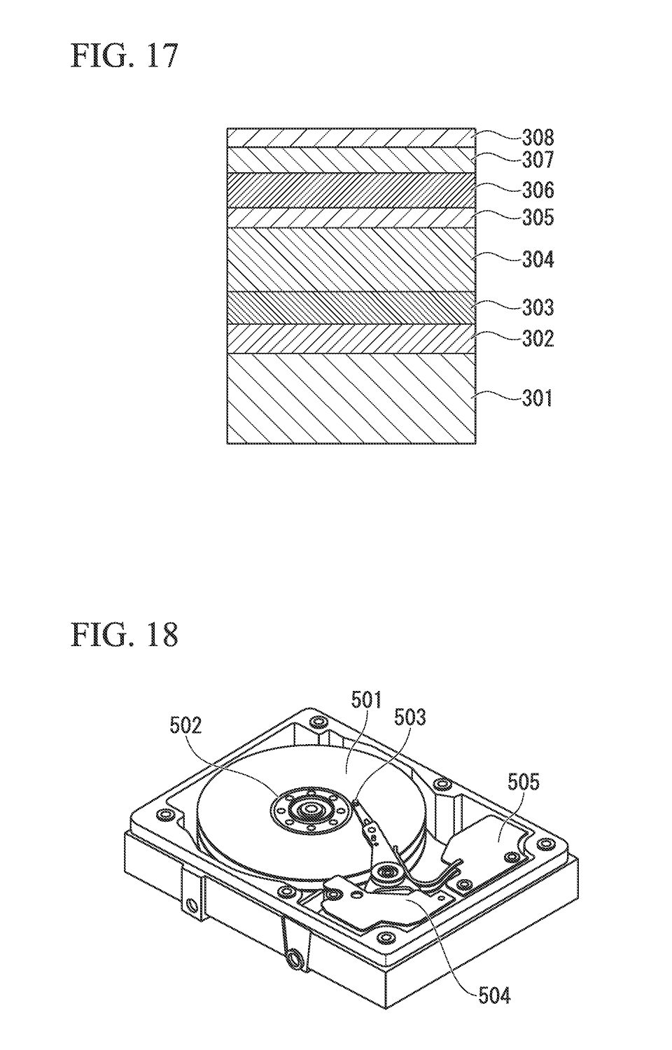

One example of the layer structure of a thermally assisted magnetic recording medium produced in Example 3 is shown in FIG. 17.

The thermally assisted magnetic recording medium in the Example 3 was formed by forming an underlayer 302, which is made of a Co-50 at % Ti alloy and has a thickness of 10 nm, a heat sink layer 303, which is made of Cu and has a thickness of 200 nm, a soft magnetic underlayer 304, which is made of a CoFeTaZrB alloy and has a thickness of 15 nm, and an underlayer 305, which is made of Pd and has a thickness of 10 nm and is antiferromagnetically bonded with the soft magnetic layer 304 each other, were formed on a glass substrate 301 in this order; and then the glass substrate 301 was heated to 350° C.; and the first magnetic layer 306, which has a thickness of 13 nm, a second magnetic layer 307, which is made of Fe-27 at % Co-10 at % Ta alloy and has a thickness of 5 nm, and a protective layer 308, which is made of C and has a thickness of 3 nm, were formed in this order.

The first magnetic layer 306 was formed by forming successively a layer made of (Co-50 at % Pt)-20 mol % SiO₂ having a thickness of 5 nm, a layer made of (Co-50 at % Pt)-15 mol % SiO₂ having a thickness of 2 nm, a layer made of (Co-50 at % Pt)-10 mol % SiO₂ having a thickness of 2 nm, a layer made of (Co-50 at % Pt)-5 mol % SiO₂ having a thickness of 2 nm, and a layer made of Co-50 at % Pt having a thickness of 2 nm.

These layer were formed by using a CoPt—SiO₂ complex target having a different concentration of SiO₂ in a different film-forming chamber. In this Example, the multilayer made of five layers containing CoPt—SiO₂ was used as the first magnetic layer 306.

In addition, a thermally assisted magnetic recording medium (No. 3-2) including a monolayer which is made of (Co-50 at % Pt)-20 mol % SiO₂ and has a thickness of 13 nm as the first magnetic layer 306 and a thermally assisted magnetic recording medium (No. 3-3) including a monolayer which is made of (Co-50 at % Pt)-5 mol % SiO₂ and has a thickness of 13 nm as the first magnetic layer 306 were also produced as a Comparative Example. The Comparative thermally assisted magnetic recording media (Nos. 3-2 and 3-3) have the same layer structure and are produced by the same method as those of the thermally assisted magnetic recording medium (No. 3-1) in Example 3.

TABLE 2

| No. | First magnetic layer | ΔHc/Hc | Hc/Hco | Note |
|---|---|---|---|---|
| 3-1 | Multilayer | 0.37 | 0.32 | Example |
| 3-2 | Monolayer made of | 1.01 | 0.35 | Comparative |
| | (Co-50 at % Pt)-20% | | | Example |
| | by mole of SiO₂ | | | |
| 3-3 | Monolayer made of | 0.34 | 0.15 | Comparative |
| | (Co-50 at % Pt)-5% | | | Example |
| | by mole of SiO₂ | | | |

As a result of X-ray diffraction analysis of the thermally assisted magnetic recording media No. 3-1 to No. 3-3, a L1₁-CoPt (111) diffraction peak and a L1₁-CoPt (333) diffraction peak were observed in all the first magnetic layer 306. Based on this result, it was confirmed that the CoPt alloy has an excellent L1₁ ordered structure.

When the thermally assisted magnetic recording media No. 3-1 to No. 3-3 were heated to 280° C. to 360° C., the coercive force (Hc) and the coercive force distribution (ΔHc/Hc) were measured, and the ΔHc/Hc when the Hc was 5 kOe was estimated. In addition, the dynamic coercive force Hc₀ at the temperature when Hc is 5 kOe was also measured. Here, the Hc₀ was calculated using the Sharrock equation based on the fact that Hc depends on the magnetic field application rate. In general, Hc/Hco shows the strength of the exchange bonding between the magnetic particles, and this is smaller as the exchange bonding is larger. ΔHc/Hc and Hc/Hco of the thermally assisted magnetic recording media No. 3-1 to No. 3-3 are shown in Table 2.

As shown in Table 2, ΔHc/Hc of the thermally assisted magnetic recording medium No. 3-1 in Example 3 was 0.37. Hc/Hco was relatively high, such as 0.32. Based on these results, it was confirmed that the exchange bonding decreases.

In contrast, Hc/Hco of the Comparative thermally assisted magnetic recording medium No. 3-2 has substantially the same level as that of the thermally assisted magnetic recording medium No. 3-1 in Example 3; however, ΔHc/Hc was extremely high, such as 1.01. This means that the exchange bonding between the magnetic particles in the comparative thermally assisted magnetic recording medium No. 3-2 is lower, which is the same level as the thermally assisted magnetic recording medium No. 3-1 in Example 3, but the coercive force distribution of the comparative thermally assisted magnetic recording medium No. 3-2 was extremely large.

On the other hands, regarding the comparative thermally assisted magnetic recording medium No. 3-3, Hc/Hco is smaller and substantially the same level as that of the thermally assisted magnetic recording medium No. 3-1 in Example 3, however, ΔHc/Hc was extremely low, such as 0.12. This means that the coercive force distribution is reduced by decreasing the content of the SiO₂ (grain boundary segregation-material); however, the exchange bonding between the magnetic particles was extremely large. Therefore, it was clear that a reduction of the coercive force distribution without an increase of the exchange bonding between the magnetic particles is difficult only by simply reducing the content of the grain boundary segregation-material.

As explained above, it is clear that in order to reduce the coercive force distribution without increasing the exchange bonding between the magnetic particles, a decrease of the content of the grain boundary segregation-material in the first magnetic layer 306 from the side of the glass substrate 301 to the side of the second magnetic layer 307 is effective as in the present invention.

Moreover, the second magnetic layer 307 may be made of CoCr alloys, CoCrPt alloys, CoCrPtTa alloys, or CoCrPtB alloys, which have HCP crystal lattice structure, in addition to the FeCoTa alloy used in Example 3.

### Example 4

In Example 4, after coating a perfluoro polyether-based lubricant to the surface of the thermally assisted magnetic recording media produced in Examples 1 to 3, the thermally assisted magnetic recording media were introduced into the magnetic recording and reproducing device shown in FIG. 18.

The magnetic recording and reproducing device shown in FIG. 18 includes the thermally assisted magnetic recording medium 501; a medium driving portion 502 for driving the thermally assisted magnetic recording medium 501 in a recording direction; a magnetic head 503 for recording information to the thermally assisted magnetic recording medium 501 and reproducing information of the thermally assisted magnetic recording medium 501; a head movement device 504 for moving the magnetic head 503 relatively to the thermally assisted magnetic recording medium 501; and a recording and reproducing signal-processing device 505 for inputting a signal to the magnetic head 503 and reproduction output signal from the magnetic head 503. Moreover, the magnetic recording and reproducing device further includes a laser generation device for generating a laser, and a waveguide for transferring the laser generated to the magnetic head 503, which are not shown in FIG. 18.

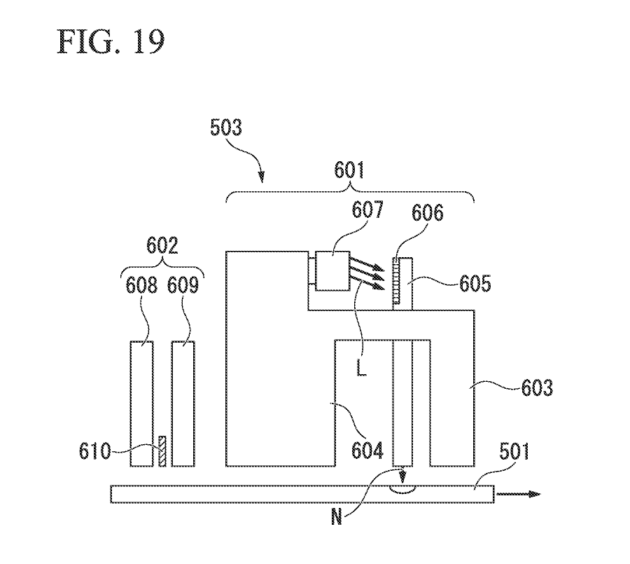

The magnetic head 503 provided in the magnetic recording and reproducing device is schematically shown in FIG. 19. The magnetic head 503 includes a recording head 601 and a reproducing head 602. The recording head 601 further includes a main pole 603, an auxiliary pole 604, and a planar solid immersion mirror (PSIM) 605 between them. The PSIM 605 may be a PSIM disclosed in Jpn., J. Appl. Phys., vol. 145, No. 2B, pp 1314-1320 (2006). In the recording head 601, laser light L having a wavelength of 440 nm generated in a laser light source 607 is radiated to a grating portion 606 of the PSIM 605, and the thermally assisted magnetic recording medium 501 is recorded while being heated with near-field light NL generated from the chip of the PSIM 605. On the other hand, the reproducing head 602 includes an upper shield 608 and a lower shield 609, and a TMR element 610 between them.

When the thermally assisted magnetic recording medium 501 was heated by the magnetic head 503, recorded with a linear recording density of 21,800 kFCI (kilo Flux Changes per Inch), and electromagnetic conversion properties were measured, excellent overwrite properties having a high SN ratio of 15 dB or more could be obtained.

### EXPLANATION OF REFERENCE SYMBOL

101 glass substrate
102 underlayer
103 soft magnetic underlayer
104 underlayer
105 underlayer
106 first magnetic layer
107 second magnetic layer
108 protective layer
201 glass substrate
202 underlayer
203 underlayer
204 heat sink layer
205 underlayer
206 first magnetic layer
207 second magnetic layer
208 protective layer
301 glass substrate
302 underlayer
303 heat sink layer
304 soft magnetic underlayer
305 underlayer
306 first magnetic layer
307 second magnetic layer
308 protective layer
501 thermally assisted magnetic recording medium
502 medium driving portion
503 magnetic head
504 head movement device
505 recording and reproducing signal-processing device
601 recording head
602 reproducing head
603 main pole
604 auxiliary pole
605 PSIM
606 grating portion
607 laser light source
608 upper shield
609 lower shield
610 TMR element
L laser light
NL near-field light

1. A thermally assisted magnetic recording medium having a structure in which a first magnetic layer and a second magnetic layer are formed on a substrate in this order, wherein the first magnetic layer has a granular structure containing a FePt alloy having a L1₀ structure, a CoPt alloy having a L1₀ crystal lattice structure or a CoPt alloy having a L1₁ crystal lattice structure, and at least one material for causing grain boundary segregation selected from the group consisting of SiO₂, TiO₂, Cr₂O₃, Al₂O₃, Ta₂O₅, ZrO₂, Y₂O₃, CeO₂, MnO, TiO, ZnO, and MgO, and the content of the material for causing grain boundary segregation in the first magnetic layer is decreased from the substrate side to the second magnetic layer side.

2. The thermally assisted magnetic recording medium according to claim 1, wherein the first magnetic layer includes a fixed-content area of which the content of the material for causing grain boundary segregation is fixed from the substrate side to the second magnetic layer side and a decreased-content area of which the content of the material for causing grain boundary segregation is decreased from the substrate side to the second magnetic layer side.

3. The thermally assisted magnetic recording medium according to claim 2, wherein the percentage of the thickness of the fixed-content area in the total thickness of the first magnetic layer is 70% or less.

4. The thermally assisted magnetic recording medium according to claim 2, wherein the content of the material for causing grain boundary segregation in the fixed-content area is 30% by volume or more.

5. The thermally assisted magnetic recording medium according to claim 1, wherein the second magnetic layer is made of an amorphous alloy containing Co and at least one of Zr, Ta, Nb, B, and Si.

6. The thermally assisted magnetic recording medium according to claim 1, wherein the second magnetic layer is made of an amorphous alloy containing Fe and at least one of Zr, Ta, Nb, B, and Si.

7. The thermally assisted magnetic recording medium according to claim 1, wherein the second magnetic layer is made of an alloy containing Fe and having a BCC crystal lattice structure or a FCC crystal lattice structure.

8. The thermally assisted magnetic recording medium according to claim 1, wherein the second magnetic layer is made of an alloy containing Co and having a HCP crystal lattice structure.

9. The thermally assisted magnetic recording medium according to claim 1, wherein a magnetocrystalline anisotropy constant of the second magnetic layer is smaller than a magnetocrystalline anisotropy constant of the first magnetic layer.

10. A magnetic recording and reproducing device including:
the thermally assisted magnetic recording medium according to claim 1;
a medium driving portion for driving the thermally assisted magnetic recording medium in a recording direction;
a magnetic head which includes a laser generation portion for heating the thermally assisted magnetic recording medium and a waveguide for introducing a laser generated in the laser generation portion to an edge portion, and which records and reproduces the thermally assisted magnetic recording medium;
a head movement device for moving the magnetic head relatively to the thermally assisted magnetic recording medium; and
a recording and reproducing signal-processing device for inputting a signal to the magnetic head and reproducing an output signal from the magnetic head.
